(19) United States
(12) Patent Application Publication
(10) Pub. No.: US 2003/0149726 A1
(43) Pub. Date: Aug. 7, 2003

(54) Automating the reduction of unsolicited email in real time

(75) Inventor: Steven W. Spear, Piscataway, NJ (US)

Correspondence Address: BANNER & WITCOFF, 1001 G STREET N W, SUITE 1100, WASHINGTON, DC, 20001, US

(73) Assignee: AT&T Corp., New York, NY

(21) Appl. No.: 10/068,090

(22) Filed: Feb. 5, 2002

(51) Int. Cl. G06F 15/16

(52) U.S. Cl. 709/206

(57) ABSTRACT

A method and apparatus for reducing unsolicited bulk email, or spam, to a computer network is described having a gateway, a mail queue, and a delay queue. The gateway handles input/output for the computer network communicating outside of the computer network. The gateway may make an initial determination of a likelihood that incoming mail is spam and deliver likely spam to the delay queue, or all incoming mail may be delivered to the delay queue. Email delivered to the delay queue is held in the delay queue for a configurable amount of time, or until is determined to either be undesirable or permissible. Once an email is determined likely not to be spam or permissible, it is delivered to the mail queue for delivery to the intended recipient. Email determined to be undesirable or likely to be spam may be discarded, returned to the sender, or held for further inspection.

### FIELD OF THE INVENTION

The invention relates to electronic mail processing and distributing, and particularly to the filtering of unsolicited and undesirable electronic mail messages in real time by a receiving computer mail server prior to distribution to the sender's intended recipient.

### BACKGROUND OF THE INVENTION

Virtually every user of electronic mail (email) is a target of unsolicited email, often referred to as junk email, unsolicited bulk email (UBE), or spam. No perfect system simultaneously allows some email users to avoid junk email, some email users to receive junk email, and all email users to receive desirable mail. A wide assortment of approaches have been and are being developed for dealing with the problem, made clear by the title and text of the article, G. Robbins, J. Ferri, Mail Control: Filtering Spam Through a Mix of Technology, Legislation and the Courts, Intellectual Property Today, December 2001, pp.6-9.

In order for an organization or private Internet user to connect to the internet, a server system is required. In order to send and receive email, a mail server protocol is incorporated into the server system. The mail server has a registered DNS entry corresponding to the server and specific to a domain name specific to that server.

The domain name is public information, and oftentimes email addresses hosted by the mail server become public. Small companies mine the email data from connections to Internet Service Providers (ISPs), and from email addresses in messages in public newsgroups. Once an email user provides their address to an organization, it often becomes an asset of that company. For instance, the email address of a user who purchases online goods or services from a company becomes a commodity or asset.

The use of that asset is subject only to a privacy policy of that company, and the degree to which the company adheres to that policy.

A considerably large industry has developed to cull and collect the email addresses of people. Typically, the collecting of email addresses is geared towards distributing advertising to the people whose email addresses are collected. Online business often sell these email addresses in the same way that credit card companies and the like sell addresses. The use of cookies and meta-tagging to information distributed over the internet is another way in which information about the user is gleaned. In this manner, an email and online user becomes a target of advertising.

A further manner in which email addresses become public or become known to bulk emailers is through sheer trial and error. Specifically, a computer may be used to generate as many email addresses as possible for well-known hosts. For example, knowing popular names have already been registered as email address for a large ISP company, one could simply send email to names such as john@ISP.com, sara@ISP.com, bob@ISP.com, etc. In addition, it is common to simply add a number to the address or screenname. For instance, one would have a high probability of finding a real email address if email were sent to john1@ISP.com, john2@ISP.com, john3@ISP.com, john4@ISP.com, etc.

Because of the availability of what are claimed to be “Direct Marketing Tools,” it is now quite common to see the same message sent through multiple mail gateways as fast as the sending client can to millions of users over many hours. Many of these bulk email distributors send spam during non-working hours in order to avoid the chance of human detection until all messages have been sent.

On occasion, this advertising provides useful information to the email user. For instance, someone who registers their email address to receive information from an airline company regarding fare discounts may be targeted by online discount airline booking services.

More often, the user becomes deluged with unsolicited email that is undesirable. Often times, the email is not only undesirable but also violates their employer's internet and email usage policies. For instance, pornographic solicitations whose very language is repugnant to the user may be sent, and the receipt of those solicitations may be against an employer's stated policy prohibiting email accounts to be used for the receipt or distribution of offensive materials. In the same way that junk postal mail is distributed in mass with the hope that an extremely small portion of the receiving population is interested in the offers, junk email distributors (often called spammers) hope that a small portion either are interested in the offers or are tricked into opening a website. Upon the accidental opening of a website, the distributor earns a small reward as the website tracks user counts or hits (visits). The advertising revenues of a site are almost exclusively dependent on the hits to that website.

Huge volumes of bulk email are sent unsolicited by senders who have little regard for those who are receiving it. As discussed, this not only wastes the human resources of a company or recipient, but also the systems resources of an Internet service provider (ISP). Unlike traditional postal bulk mail, bulk email senders bear virtually no cost in sending a huge amount of email. However, an ISP's resources must handle and deliver the incoming mail at great cost in resources. In some practices, that cost in resources may include man-hours for supervising incoming email to a network, man-hours for recipients to delete emails, and network resources for receiving, evaluating, delivering, storing, or discarding junk emails. A failure of an ISP to provide sufficient resources for processing mail results in slow networks and dissatisfied users who are unable to access the information as rapidly as they would desire. The occurrence of an organization's network being besieged by a spam email of significance often leads to the organization barring any email from the originating distributor. However, this may block all email from a sending ISP, which causes legitimate mail from the ISP to be denied.

Previously, it has been difficult to control the receipt of unsolicited email. The sheer speed and volume of email that may be received by a large ISP makes it clear the need to avoid the undesirable, and possibly unethical, result of having humans read message logs and actual messages for building company-wide or user-specific rule sets. In a business environment, employee time (i.e., man-hours) is required for an email user to examine the message and determine it is junk to be ignored. The reality is that a human-inspected regimen for handling email means that the least valuable emails (spam) get the most scrutiny and, therefore, get the most human attention and man-hours. Conversely, those who are properly using email to converse with known associates and friends.

Various methods have been attempted to prevent the email from ever reaching the email account holder to have to deal with the mail. For instance, some mail servers utilize a protocol whereby every email is examined for specific language that would indicate the email is undesirable (such as “sex” or “make money”). This can be a problem if the email must be opened (which may trigger a virus) and, in any event, requires processing power which has an attendant cost to the organization operating the server. There have been attempts at heuristic and weighting protocols for examining the emails, these attempts simply being a variation of examining the contents or other information contained in the message. These approaches also cause a delay in the delivery of email as the message is examined, particularly at a large organization which may receive a considerable amount of messages in a short period of time.

Another method that has been tried requires multiple communications with the supposed sender's server. If the sender's email address is fictitious, the receiving server will not be able to communicate with the sender's server. However, this takes time and cannot be done in real-time. This also does not eliminate messages sent with real senders' addresses.

Another method requires a user to specify addresses. This can be done in two ways: one, the user specifies addresses from which mail should be delivered; and two, the user specifies addresses from which mail is not to be delivered. However, this requires a user to specify each and every address. Somewhat akin to this method is the method of U.S. Pat. No. 6,266,692, to Greenstein. Greenstein requires distributors of email to include in the header a specified password, thereby indicating to the recipient's server that the email is to be delivered to the recipient. Both of these methods are not practical to a business professional who may be contacted by someone to whom a business card has been provided, by a referral, or by someone who has gotten the professional's address through a legitimate source such as a commercial advertisement, promotional literature, or website.

U.S. Pat. No. 6,052,709, to Paul, describes an attempt to reduce the burden of spam. The invention of '709 creates fictitious email addresses termed “spam probe” email addresses. These email addresses are distributed around a network where those who collect email addresses for spamming purposes may gather the addresses. These addresses are then included in the spammers email lists. When an email is sent to a server and the intended recipient is one of the spam probe addresses, an alarm signal is generated and distributed throughout the network. Among the problems with this system and method is the sheer volume that can be delivered to a network. The delivery of a thousand emails in a single second across the internet to or from a single is supported by today's hardware. The invention of '709 continues to deliver email until a spam probe address is specified as an intended recipient, by which time many emails may have already been delivered-by the recipient server. Each of those emails would then need to be deleted by the recipient, or network resources may be used to retrieve all those that remain unopened. In any event, every junk email that escaped initial detection would cause a waste of network resources.

U.S. Pat. No. 6,167,434, to Pang, describes an attempt to notify unsolicited email distributors of a user's desire to be removed from the distributor's email list. Pang notes it is not uncommon for unsolicited email to include a feature whereby one can reply to the email and request deletion or removal from the distributor's list. This is commonly done by returning an email the subject line of which reads “unsubscribe,” or “remove,” or some other like message. The invention of Pang is most particularly a computer program or application that automatically generates the messages by reading, in a sense, the unsolicited email and recognizing the intended manner for notifying the distributor of the desire to be removed. Pang includes a button that becomes an add-on to common email applications, thereby enabling a user to make a single click prompting the application to notify all distributors of unsolicited email that the user desires removal and to automatically delete the email from the user's account. However, this requires user interaction, and network resources have already delivered the email to the user's account where it has been stored for some period of time, wasting additional resources. Furthermore, many bulk emailers use anonymous addresses, fictitious address, or no address at all from which to send email—and in these cases, Pang's invention would be wholly useless.

Accordingly, it has been desired for a mail server effectively to reject junk email, or spam, prior to receipt by an email account user, to do so in real time or with only a negligible delay, and to do so with a minimum of network resources. In addition, it is preferred that this could be achieved while not precluding the use of other types of email filters.

### BRIEF SUMMARY OF THE INVENTION

In accordance with one aspect of the present invention, an apparatus for reducing unsolicited emails to a computer network is disclosed including an input/output point to a computer network for receiving or transmitting information, a mail queue; and a delay queue, whereby incoming emails are placed on the delay queue for an appropriate and configurable time period, whereby at least one characteristic of the emails placed on the delay queue is examined to determine whether the emails are likely to be desirable to the intended recipient or recipients. The input/output may be at least one gateway, or may be a plurality of gateways. The mail queue and the delay queue may be co-located, or may be separately located. The delay queue may reside on a plurality of machines and poll the plurality of machines regarding the at least one characteristic of the emails on the delay queue. The characteristic of the emails may be the sender's IP, MAC address, sender's address, recipient address, number of recipients, number of invalid recipients, encryption of the emails, method of encryption of the emails, authentication of the sending user, method of authentication of the sending user, subject, message-ID, or message content. The apparatus may examine and compare a plurality of characteristics of the emails.

In accordance with a second aspect of the present invention, an apparatus for reducing unsolicited bulk emails to a computer network is disclosed including an at least one gateway to a computer network for receiving or transmitting information whereby incoming emails are initially examined for being suspect as unsolicited bulk emails, a mail queue, and a delay queue, whereby suspect incoming emails are placed on the delay queue for an appropriate and configurable time period, whereby at least one characteristic of the emails placed on the delay queue is examined to determine whether the emails is likely to be desirable to the intended recipient. The emails identified as not suspect as unsolicited bulk emails may be delivered to the mail queue. Emails placed on the delay queue and found sufficiently unique as not to present a threat to the resources of the computer network may be delivered to the mail queue. Emails found to present a threat to the resources of the computer network are not delivered. Emails not delivered to the mail queue may be discarded, returned to the sender, stored for further inspection, or stored for a recipient to request. The apparatus may include network established protocols for determining whether the emails are acceptable as desired or permitted, the protocols providing rules for accepted characteristics for individual emails. The protocols are computer-executable instructions for examining the incoming emails for specific characteristics indicating the emails are acceptable, permissible, or desired by the recipient. Emails placed on the delay queue may be compared against the established protocols, and emails found acceptable may be delivered to the mail queue. Emails not delivered to the mail queue may be discarded, returned to the sender, stored for further inspection, or stored for a recipient to request.

In accordance with a further aspect of the present invention, a method of reducing unsolicited bulk emails to a computer network is disclosed including initially identifying incoming emails as suspect or not suspect, placing emails identified as suspect on a delay queue, identifying at least one characteristic of the emails, and comparing said at least one characteristic of the emails placed on the delay queue to determine a likelihood that emails with similar characteristics are likely unsolicited bulk emails. The method may include the step of delivering emails identified as not suspect to a mail queue for delivery to the intended recipient. The step of identifying at least one characteristic of the emails may include identifying a plurality of characteristics of the emails, and said step of comparing may include comparing said plurality of characteristics of the emails placed on the delay queue to determine a likelihood that emails with similar characteristics are unsolicited bulk emails. The method may include the steps of configuring a delay time for the delay queue, delaying said emails on the delay queue for the delay time, and comparing said plurality of characteristics of the emails placed on the delay queue during the delay time to determine a likelihood that emails with similar characteristics are likely unsolicited bulk emails. The method may include the steps of determining emails placed on the delay queue whose characteristics are not sufficiently similar to other emails simultaneously on the delay queue are not likely to be unsolicited bulk email, and delivering emails which are not determined likely to be unsolicited bulk email from the delay queue to the mail queue after the emails have resided on the delay queue for the delay time. The method may include the step of preventing delivery of emails determined to be likely to be unsolicited bulk email. The preventing delivery may include returning to the sender emails determined to be likely to be unsolicited bulk email. The preventing delivery may include discarding emails determined to be likely to be unsolicited bulk email. The preventing delivery may include storing emails determined to be likely to be unsolicited bulk email.

In accordance with a further aspect of the present invention, a computer-readable medium having computer-executable instructions for reducing unsolicited bulk emails to a computer network is disclosed including initially identifying incoming emails as suspect or not suspect, placing emails identified as suspect on a delay queue, identifying at least one characteristic of the emails, and comparing the at least one characteristic of the emails placed on the delay queue to determine a likelihood that emails with similar characteristics are likely unsolicited bulk emails. The instructions may include the step of delivering emails identified as not suspect to a mail queue for delivery to the intended recipient. The step of identifying at least one characteristic of the emails may include identifying a plurality of characteristics of the emails, and said step of comparing may include comparing said plurality of characteristics of the emails placed on the delay queue to determine a likelihood that emails with similar characteristics are unsolicited bulk emails. The instructions may include the steps of configuring a delay time for the delay queue, delaying said emails on the delay queue for the delay time, and comparing said plurality of characteristics of the emails placed on the delay queue during the delay time to determine a likelihood that emails with similar characteristics are likely unsolicited bulk emails. The instructions may include the steps of determining emails placed on the delay queue whose characteristics are not sufficiently similar to other emails simultaneously on the delay queue are not likely to be unsolicited bulk email, and delivering emails which are not determined likely to be unsolicited bulk email from the delay queue to the mail queue after the emails have resided on the delay queue for the delay time. The instructions may include the step of preventing delivery of emails determined to be likely to be unsolicited bulk email. The preventing delivery may include returning to the sender emails determined to be likely to be unsolicited bulk email. The preventing delivery may include discarding emails determined to be likely to be unsolicited bulk email. The preventing delivery may include storing emails determined to be likely to be unsolicited bulk email.

### BRIEF DESCRIPTION OF THE DRAWINGS

In the drawings, FIG. 1 is a representational view of an embodiment of a server system including electronic mail capability and utilizing the present invention; and

FIG. 2 is a flowchart of an embodiment utilizing the present invention.

### DETAILED DESCRIPTION OF THE INVENTION

Referring initially to FIG. 1, a server system 10 utilizing aspects of the present invention is depicted. The server system 10 may be a communications network that is connected to the Internet (INT) or another wide area or local area network. As is common and typical, the server system 10 includes at least one gateway 12, a mail queue 14, and an administration daemon 16. The gateway 12 is a direct connection to the Internet, for instance, or other communications networks. Typically, various networks are incompatible to some degree for a variety of reasons. The gateway 12 enables the server system 10 to communicate properly with other networks. The gateway 12 may be an entry point for incoming information (input) I, such as mail or files transferred from other networks, and may be an exit point for outgoing information (output) O for information being sent from some point on the server system 10 to other networks. In an alternative embodiment, the server system 10 may include multiple gateways, all of which are represented in FIG. 1 by the gateway 12.

Some of the incoming information I is electronic mail (email). In typical usage, email is initially received by the gateway 12 and then sent to the mail queue 14. The mail queue 14 temporarily holds the emails while awaiting some action. The awaited action in a typical server system may simply be waiting for available network resources, or may be awaiting a user 15 (recipient) to request recent mail. The email typically would, at some point, be delivered to the destination address which specifies the recipient and recipient account, typically via a mail server 17.

In an embodiment of the present invention, a delay queue 18 is included. The delay queue 18 may be co-located with the mail queue 14 or maybe a separate machine. The delay queue 18 may also be a software application or protocol so that the mail queue 14 may perform the functions of both the mail queue 14 and the delay queue 18. In one embodiment, all email suspected to be junk email and received by an organization's gateway 12 or gateways is initially sent to a delay queue 18. Whether all messages delivered to an organization's network is sent to a singe delay queue 18 or several ordered queues is immaterial, and the delay queue 18 may actually be the linking of delay queues 18 resident on multiple machines: the process which sorts the queue information can either poll multiple servers and work upon the data as a whole, or messages can be moved from slave machines onto a master machine which contains the delay queue 18.

The email delivered to the delay queue 18 may be stored temporarily in a well-ordered structure by Internet protocol address, sender, subject or some other classification. In accordance with a first embodiment of the present invention, the email is held in the delay queue 18 and examined for certain characteristics. These characteristics may include the sender's Internet protocol (IP) address, MAC address, sender's address, recipient address, number of recipients, number of invalid recipients, if and how the message was encrypted during transport, if and how the sending user was authenticated, the subject, the message-ID, and the body of the message (ie, message content). The characteristics chosen may correspond to characteristics that are typically associated with unwanted email. For example, a single sender's address sent to numerous employees of an enterprise may reveal that the email is an unwanted advertisement.

The email held in the delay queue 18 may be stored on a rolling basis for a configurable amount of time. That is, a configurable time is selected in the order of 90 seconds. Email in the delay queue 18 is periodically evaluated by software to initially determine if the email is unwanted or the amount of damage a particular message will cause when the entire delay queue is considered. For example, emails that look significantly alike and that are sent to several recipients may be held for further inspection, possibly human inspection.

During the time while in the delay queue 18, the above-mentioned characteristics of the suspect email may be compared with the characteristics of the other emails whose delay in the delay queue 18 overlap with that of the suspect email. The emails that are found to be sufficiently unique, sufficiently small in number as not to be considered a problem, or otherwise considered not to be junk mail, may be delivered to the proper mail queue 14 and sent on to the intended recipient. Emails that do not satisfy the prescribed criteria in order to be normally processed may be discarded, stored, or sent back to the original sender (recognizing that the address the sender provided probably is fictitious). In this manner, the total human attention needed to run large services is greatly reduced and the message latency per message becomes shorter and more consistent than would otherwise be possible.

In this manner, no human interaction need be involved. However, human interaction for particular flagged groups of emails could be used and is not prevented. In an embodiment of the present invention, emails stored for further inspection by a human can be presented in digest form with the ability to inspect each message in detail if necessary. The human may decide what to do with the messages in the delay queue 18, and may use a graphical user interface 20 that requires a minimal amount of handstrokes or mouse-clicks.

Aspects of the present invention may be used to defeat spam where other systems and methods have failed. For instance, it is not altogether uncommon for the text of spam messages to be encrypted. In this manner, methods that look for particular words (such as “sex” or “cash”) are defeated. However, disclosed embodiments of the present invention will recognize the emails containing identical characteristics regardless of whether the email is encrypted or not.

Alternative embodiments of the present invention may utilize the prior art systems and methods described above, as well as other junk email suppression systems and methods. As has been discussed, some methods require recipient's or the recipient organization to build a list of permitted senders, to build a list of rules on permissible email, or look for passwords contained in the email. In one embodiment, the present invention allows for configuring of the mail queue 14 and delay queue 18 so that trusted or authenticated senders can be delivered directly without a delay or without ever being put on the delay queue 14 (such as being sent directly from the gateway 12 to the mail queue 14, thereby bypassing the delay queue 18).

Methods that build lists of known patterns for identifying junk mail can also be incorporated. Lists of previously known patterns can be applied to either indicate an individual message is suspicious or permit the message to entirely avoid the delay queue 18.

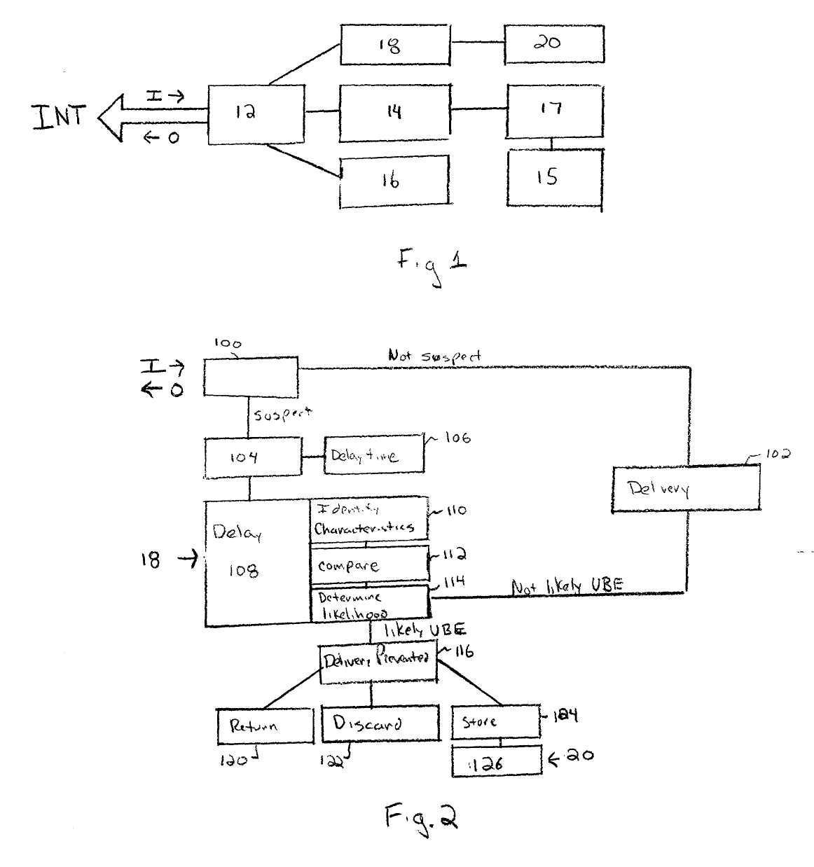

The operation of an embodiment of the present invention is depicted in FIG. 2. Input/output is received at block 100 where an initial identification may be made as to whether an email is considered suspect or not suspect, suspect being likely to be unsolicited bulk email. As an example, an e-mail message that is addressed to 100 or more recipients may be initially identified as suspect. If the email is not suspect, the email may be sent to block 102 for delivery to the intended recipient. The emails identified as suspect are placed on the delay queue 18, this being represented by block 104. A delay time may be configured as is represented by block 106, and the emails on the delay queue 18 are delayed on the delay queue 18 for the period of the delay time, as is represented by block 108. Concurrent with the emails being delayed on the delay queue 18, characteristics of the delayed emails (discussed above) are identified (represented by block 110), the characteristics of the emails are compared to the other emails in the delay queue 18 (represented by block 112), and the likelihood of each email being unsolicited bulk email is determined based on these characteristics (represented by block 114). Emails that are determined not likely to be unsolicited bulk email (UBE) are sent to block 102 for delivery to the intended recipient. Emails that are determined likely to be unsolicited bulk email are sent to block 116 where their delivery is prevented. The emails determined likely to be unsolicited bulk email may be returned (block 120), discarded (block 122), stored (block 124), or otherwise not delivered, which may include examination by a human such as at a graphical user interface (GUI) 20 represented by block 126.

While the invention has been described with respect to specific examples including presently preferred modes of carrying out the invention, those skilled in the art will appreciate that there are numerous variations and permutations of the above described systems and techniques that fall within the spirit and scope of the invention as set forth in the appended claims.

1. An apparatus for reducing unwanted emails to a computer network comprising:
an input/output point coupled to a computer network;
a mail queue; and
a delay queue coupled to the input/output point and the mail queue, whereby incoming email messages are placed on the delay queue, and whereby at least one characteristic of the email message placed on the delay queue is examined to determine whether the email message are likely to be desirable to the intended recipient or recipients.

2. The apparatus of claim 1 wherein the email messages are placed on the delay queue for a configurable time period.

3. The apparatus of claim 1 wherein the input/output point comprises at least one gateway.

4. The apparatus of claim 1 wherein the input/output point comprises a plurality of gateways.

5. The apparatus of claim 1 wherein the mail queue and delay queue are co-located.

6. The apparatus of claim 1 wherein the delay queue resides on a plurality of machines and wherein the delay queue polls the plurality of machines regarding the at least one characteristic of the emails on the delay queue.

7. The apparatus of claim 1 wherein the at least one characteristic of the emails placed on the delay queue is the sender's Internet protocol address.

8. The apparatus of claim 1 wherein the at least one characteristic of the emails placed on the delay queue is the email's MAC address.

9. The apparatus of claim 1 wherein the at least one characteristic of the emails placed on the delay queue is the number of recipients.

10. The apparatus of claim 1 wherein the at least one characteristic of the emails placed on the delay queue is the sender's address.

11. The apparatus of claim 1 wherein the at least one characteristic of the emails is selected from the group of:
recipient address, number of invalid recipients, encryption of the emails, method of encryption of the emails, authentication of the sending user, method of authentication of the sending user, subject, message-ID, or message content.

12. The apparatus of claim 1 wherein a plurality of characteristics of the emails placed on the delay queue are examined, the characteristic of the emails being selected from the group of:
sender's IP, MAC address, sender's address, recipient address, number of recipients, number of invalid recipients, encryption of the emails, method of encryption of the emails, authentication of the sending user, method of authentication of the sending user, subject, message-ID, or message content.

13. An apparatus for reducing unsolicited bulk emails to a computer network comprising:
an at least one gateway to a computer network for receiving or transmitting information whereby incoming emails are initially examined for being suspect as unsolicited bulk emails;
a mail queue; and
a delay queue, whereby suspect incoming emails are placed on the delay queue for an appropriate and configurable time period, whereby at least one characteristic of the emails placed on the delay queue is examined to determine whether the emails is likely to be desirable to the intended recipient.

14. The apparatus of claim 13 wherein emails identified as not suspect as unsolicited bulk emails are delivered to the mail queue.

15. The apparatus of claim 13 wherein said emails placed on the delay queue and found sufficiently unique as not to present a threat to the resources of the computer network are delivered to the mail queue.

16. The apparatus of claim 15 wherein said emails found to present a threat to the resources of the computer network are not delivered to destination addresses.

17. The apparatus of claim 16 wherein said emails not delivered to the mail queue are discarded, returned to the sender, stored for further inspection, or stored for a recipient to request.

18. The apparatus of claim 13 further including computer-executable instructions for determining whether the emails are acceptable as desired or permitted, said computer-executable instructions providing rules for accepted characteristics for individual emails.

19. The apparatus of claim 18 wherein said emails placed on the delay queue are compared against established protocols, and wherein emails found acceptable are delivered to the mail queue.

20. The apparatus of claim 19 wherein said emails not delivered to the mail queue may be discarded, returned to the sender, stored for further inspection, or stored for a recipient to request.

21. A method of reducing unwanted email messages received at a computer network, the method comprising:
(a) storing an email message on a delay queue;
(b) identifying at least one characteristic of the email message stored on the delay queue; and
(c) comparing said at least one characteristic of the email message stored on the delay queue with corresponding characteristics of other email messages stored on the delay queue to determine a likelihood that the email message is an unwanted e-mail message.

22. The method of claim 21 further including initially identifying incoming email messages as suspect or not suspect, whereby email messages identified as suspect are stored on the delay queue.

23. The method of claim 22 further including delivering email messages identified as not suspect to a mail queue for ultimate delivery to the intended recipient.

24. The method of claim 21 wherein (c) includes comparing a plurality of characteristics of the email message with corresponding characteristics of other email messages.

25. The method of claim 24 further including:
receiving a delay time at the delay queue; and
storing the email message on the delay queue for the delay time.

26. The method of claim 25 further including:
after determining in (c) that the email message is likely not an unwanted message, delivering the email message to the mail queue.

27. The method of claim 26 further including:
after determining in (c) that the email message is likely an unwanted message, preventing delivery of the email message.

28. The method of claim 27 wherein preventing delivery includes returning the email message to a sender.

29. The method of claim 27 wherein preventing delivery includes discarding the email message.

30. The method of claim 27 wherein preventing delivery includes storing the email message.

31. A computer-readable medium having computer-executable instructions for causing an email server to perform the steps comprising:
placing emails on a delay queue;
identifying at least one characteristic of the emails placed on the delay queue; and
comparing said at least one characteristic of the emails placed on the delay queue to determine a likelihood that emails with similar characteristics are likely unsolicited bulk emails.

32. The computer readable medium of claim 31 further comprising computer-executable instructions for performing the step of initially identifying incoming emails as suspect or not suspect, whereby emails identified as suspect are placed on the delay queue.

33. The computer readable medium of claim 32 having further computer-executable instructions for performing the step of delivering emails identified as not suspect to a mail queue for delivery to the intended recipient.

34. The computer readable medium of claim 31 wherein said step of identifying at least one characteristic of the emails includes identifying a plurality of characteristics of the emails, and wherein said step of comparing includes comparing said plurality of characteristics of the emails placed on the delay queue to determine a likelihood that emails with similar characteristics are unsolicited bulk emails.

35. The computer readable medium of claim 34 further comprising computer-executable instructions for performing the steps of:
configuring a delay time for the delay queue;
delaying said emails on the delay queue for the delay time; and
comparing said plurality of characteristics of the emails placed on the delay queue during the delay time to determine a likelihood that emails with similar characteristics are likely unsolicited bulk emails.

36. The computer readable medium of claim 35 further comprising computer-executable instructions for performing the steps of:
determining emails placed on the delay queue whose characteristics are not sufficiently similar to other emails simultaneously on the delay queue are not likely to be unsolicited bulk email; and
delivering emails which are not determined likely to be unsolicited bulk email from the delay queue to the mail queue after said emails have resided on the delay queue for the delay time.

37. The computer readable medium of claim 36 further comprising computer-executable instructions for performing the step of preventing delivery of emails determined to be likely to be unsolicited bulk email.

38. The computer readable medium of claim 37 wherein said step of preventing delivery includes returning to the sender emails determined to be likely to be unsolicited bulk email.

39. The computer readable medium of claim 37 wherein said step of preventing delivery includes discarding emails determined to be likely to be unsolicited bulk email.

40. The computer readable medium of claim 37 wherein said step of preventing delivery includes storing emails determined to be likely to be unsolicited bulk email.
